(19) United States
(12) Patent Application Publication
(10) Pub. No.: US 2009/0259571 A1
(43) Pub. Date: Oct. 15, 2009

(54) INVENTORY MODULE FOR A VIDEO MONITORING SYSTEM, METHOD FOR TAKING INVENTORY OF A MONITORING REGION, AND A COMPUTER PROGRAM

(76) Inventors: Julia Ebling, Hildesheim (DE); Jan Karl Warzelhan, Hildesheim (DE); Matthias Koenig, Hildesheim (DE)

Correspondence Address: Striker, Striker & Stenby, 103 East Neck Road, Huntington, NY, 11743, US

(21) Appl. No.: 12/371,970

(22) Filed: Feb. 17, 2009

(30) Foreign Application Priority Data
Apr. 11, 2008 (DE) 102008001126.6

(51) Int. Cl. G06Q 10/00; H04N 5/225; G06F 17/30

(52) U.S. Cl. 705/28; 348/169; 707/104.1; 707/104.1

(57) ABSTRACT

An inventory module for a video monitoring system including at least one monitoring camera which is directed or directable to a monitoring region, in particular a storage and/or sales area which contains products, including a detection device which is designed to detect products, and when detection takes place, position information and information regarding the identification of detected product are ascertained, includes an assignment device which is designed to model—based on the position information and the identification information of a plurality of detected products—a spacial distribution of the products in the monitoring region.

### CROSS-REFERENCE TO RELATED APPLICATION

The invention described and claimed hereinbelow is also described in German Patent Application DE 10 2008 001 126.6 filed on Apr. 11, 2008. This German Patent Application, whose subject matter is incorporated here by reference, provides the basis for a claim of priority of invention under 35 U.S.C. 119(a)-(d).

### BACKGROUND OF THE INVENTION

The present invention relates to an inventory module for a video monitoring system, the video monitoring system including at least one monitoring camera which is directed or directable to a monitoring region, in particular a storage and/or sales area, which contains products, and including a detection device which is designed to detect products; when detection is carried out, position information and identification information of the detected product are ascertained. The present invention also relates to a method for taking inventory, and to an appropriate computer program.

Video monitoring systems having a known architecture include one or more monitoring cameras which are directed to relevant monitoring regions, and they often include a monitoring center in which the image data streams from the monitoring cameras are combined, collected, and evaluated. The evaluation may be carried out manually by monitoring personnel, or in an automated manner using image-processing algorithms designed specifically for the application. Video monitoring systems of this type are installed, e.g. in order to monitor traffic, or to observe areas in museums, train stations, public spaces, and in private buildings. Video monitoring systems are often used to record and detect undesired or unusual events. This includes, e.g. detecting individuals who enter pre-defined areas, or detecting objects that were left behind, e.g. in train stations. A further application is the monitoring of sales areas, e.g. in supermarkets, in which case the video monitoring systems are used as a tool to prevent theft.

DE 10 210 926 A1 relates to a video monitoring system which is designed such that when a moving object comes to a standstill, the length of time it spends at a standstill is counted in order to generate a signal as a function of the dwell time. As a result, in a monitored scene in which moving objects such as passengers are typically located, an atypical pattern of behavior is detected immediately and is reported automatically. This monitoring system is used, e.g. to monitor a parking lot.

### SUMMARY OF THE INVENTION

An inventory module for a video monitoring system, a method for taking inventory of a monitoring region, and a computer program are provided within the scope of the present invention.

The invention that is disclosed is an inventory module for a video monitoring system, the inventory module being suitable and/or designed to inventory and/or catalog products that are preferably located in a monitoring region in a regular manner. The inventory module is preferably designed to initialize or update a data collection of the inventory or a spacial distribution of the products in the monitoring area, and/or to compare it to an expected state.

The video monitoring system includes at least one monitoring camera which is designed, e.g. as a stationary or a PTZ (pan-tilt-zoom) camera which is directed or directable to the monitoring area. The monitoring area is prefer-ably designed as a storage and/or sales area, in particular a sales area, e.g. in a supermarket. One possible advantage of the present invention is that an existing video monitoring system may be supplemented with the inventory module, so that the monitoring system may also perform the inventory function described at a lower investment cost. It is also possible, however, for the inventory module to already be implemented in the video monitoring system when a system is installed.

The subject matter of the present invention preferably also includes the video monitoring system which includes the inventory module.

The products may basically be of any type; preferably they are products for sale in the monitoring area. As an alternative, it is also possible to inventory other products, e.g. tools, consumables, pharmaceuticals, or other stored articles in a storage area. The products are preferably positioned in storage systems, e.g. shelves or the like, in a regular manner.

The inventory module includes a detection device which is designed to detect the products based on digital or analog image-processing algorithms. The detection device is designed such that, when detection is carried out, position information and identification information on the detected product are ascertained. The detection is carried out based on the image data streams which are recorded using at least one monitoring camera, and which are obtained from at least one monitoring area. The detection takes place, e.g. by calculating the feature descriptions of the products and comparing them with reference feature descriptions.

According to the present invention, it is disclosed that the inventory module includes an assignment device which is designed to model—based on the position information and identification information, and a plurality of detected products—a spacial distribution of the products in the monitoring region, in particular a storage plan for the products, which is also referred to below as product distribution.

One advantage of the present invention, therefore, is that the products in the monitoring region, e.g. in a warehouse or supermarket, may be automatically cataloged in the individual storage systems. It is therefore possible to automatically create a storage plan for the products in the monitoring area or in the store. In contrast, e.g. to RFID techniques, no additional transmitters or the like are required for product identification; such additional devices increase costs and impact the surroundings. The product distribution is preferably modeled using at least two storage systems and/or includes at least 20%, preferably at least 50%, and in particular at least 80% of the products that were detected using at least one monitoring camera.

A further possible advantage of the inventory module and/or of the possibility of automatically cataloging products in their regular positions is that the location of the products need not be redetermined manually when the monitoring area is remodeled or reorganized. The inventory module may automatically detect changes of this type and automatically adjust or update the storage plan.

According to a preferred implementation of the present invention, the inventory module includes a data base device which is designed to store the distribution of the products in the monitoring area. The data base device may have any type of architecture, and, in the simplest case, it may be designed as a list or a relational data base, data warehouse, XML container collection, etc.

According to a particularly preferred embodiment of the present invention, the data base device is designed to store a model of the monitoring area, and/or the model of the monitoring area is stored in the data base device. The model may be designed as a two-dimensional model, in particular as a basic outline, or it may be designed as a three-dimensional model which preferably extends across the areas which are monitored by a plurality of monitoring cameras. The product distribution is preferably entered in the model, or it is linked thereto, in which case “link” describes a data fusion of the distribution and the model in particular.

In a preferred embodiment of the present invention, an expected state of the distribution of the products in the monitoring region may be saved and/or is saved in the data base device, the expected state being automatically generated by the inventory module. An expected state of this type is generated in particular when the inventory module is initialized, that is, the first time when a product distribution is detected in the monitoring area or when an update is carried out after the product distribution was changed, e.g. due to a reorganization.

The inventory module is preferably designed to generate an actual state of the product distribution in the monitoring area and/or subregions thereof. The actual state is the current state of the monitoring area, as it is currently detected by the at least one monitoring camera.

According to a particularly preferred development of the present invention, the inventory module includes a comparator device which is designed to compare the actual state with the expected state of the monitoring area, and to ascertain any differences that may exist between the two. Various actions may be derived from the differences.

According to a development of the present invention, the inventory module is designed to perform a search—after all of the products in the monitoring area have been cataloged, thereby defining the expected state—for empty storage systems, in particular empty shelves, i.e. to search for places from which products have been removed. One possible action is for a signal to be released which would automatically notify the sales personnel that products must be replaced or refilled.

In an analogous manner, the inventory module may locate products that were misplaced, so that one possible action would be for a signal to be sent to the personnel to return the products to the correct place as defined by the expected state. In a preferred realization of the present invention, the data base device includes a reference data base in which the identification data of the products are stored. According to one possible realization of the detection device, the reference data base makes it possible to compare descriptions of features which are found in the current camera image of the monitoring camera with the features of the products in the reference data base. If significant conformances are found, the products may be identified and the positions of the identified products in the camera image may be determined.

According to an optional development of the present invention, the inventory module includes an object-detection device which is designed to detect moving objects, in particular individuals or shoppers, and a correlation device which correlates the position and/or moving behavior of the moving objects with the product distribution. The results from the correlation device are preferably forwarded to a control device which is designed to generate a specified response based on the results obtained from the correlation device.

It is possible, e.g. to automatically steer customers' purchasing behavior by first detecting that a customer is considering a certain product or has picked up a certain product. One possible response may be to trigger an information terminal, in particular an advertising display board, to display similar products or combination products (e.g. milk—food packages) or complementary products (e.g. shoes—shoeshine products.) It is also preferred for the inventory module to be designed—in terms of its program or circuitry—to perform the method described below, and/or for the method described below to be carried out using the inventory module.

A further object of the present invention relates to a method for taking inventory of a monitoring region, in particular a storage and/or sales region, which contains products, in the case of which the products are detected, position and identification information is ascertained, and a spacial distribution of the products in the monitoring area is modeled, as a storage plan for the products.

The method is preferably designed to carry out one, a few, or all of the following operating modes and/or functions:

Automatically initialize the monitoring area, wherein the products are searched for and the results are stored as a new site for future searches or as an expected state of the product distribution.

Compare the expected state and the actual state of the product distribution.

Detect the absence or misplacement of products, and trigger an information signal.

Monitor the expected state, wherein the products are searched for on a continual basis, so that it is always known where a product is located, or if it is even still there. In response to products being missing or misplaced, it is possible, e.g. to initiate an automatic reordering of the products, or to notify the personnel.

Detect products that have fallen to the floor.

Update the expected state of the product distribution, e.g. when the monitoring region is remodeled or reorganized, in which case it is not necessary to redetermine the location of the products manually, as this is detected automatically.

Optionally, the inventory module may automatically adjust additional devices, e.g. information terminals for position determination, so that, when a customer makes a query at the information terminal, the location of the product is output.

Steer the customer's purchasing behavior, wherein specifically tailored information based on the customer's behavior or position relative to the products is evaluated.

Optimize the storage plan for product combinations, e.g. products that are often purchased together.

A further object of the present invention relates to a computer program which includes program code means.

### BRIEF DESCRIPTION OF THE DRAWINGS

FIG. 1 shows a schematicized overview of a video monitoring system having an inventory module, as one embodiment of the present invention;

FIG. 2 shows the video monitoring system in FIG. 1, in a schematic block diagram.

### DESCRIPTION OF THE PREFERRED EMBODIMENTS

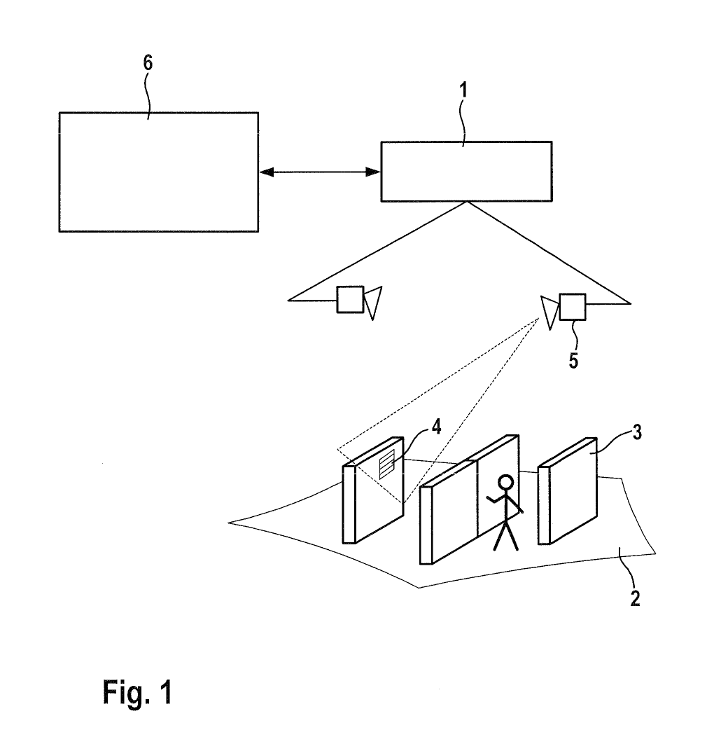

FIG. 1 shows, in a highly schematicized view, a video monitoring system 1 which is installed in order to monitor a monitoring area, e.g. a sales area 2 in this case. A plurality of shelves 3 in which various types of products 4 have been placed is installed in sales area 2. Products 4 are articles for sale, in particular, which have been organized in a certain order.

The video monitoring system includes several monitoring cameras 5 which are directed to sales area 2 and, therefore, to shelves 3 and products 4. Monitoring cameras 5 may be connected via cable or in a wireless manner to monitoring system 1; in particular, they are designed as networkable or IP cameras. The image data streams which are captured by monitoring cameras 5 are forwarded to video monitoring system 1, where they are processed.

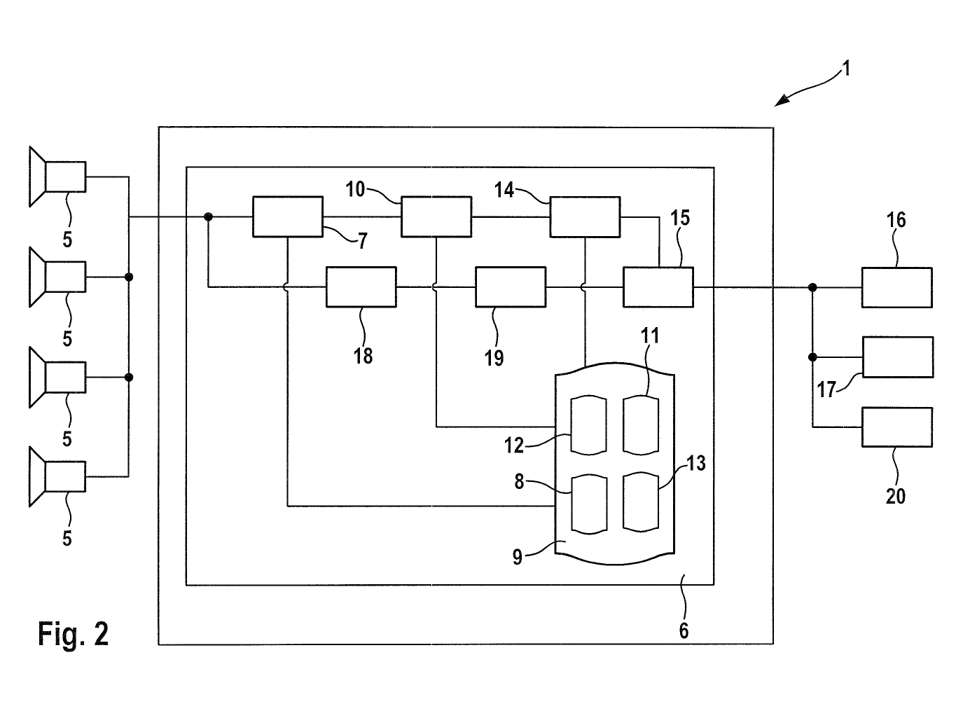

The further processing of the image data streams is explained with reference to FIG. 2 which shows a schematic block diagram of video monitoring system 1 with connected monitoring cameras 5, as an embodiment of the present invention. From monitoring cameras 5, the image data streams are directed to monitoring system 1, where they are transferred to an inventory module 6. Inventory module 6 is designed, e.g. to catalog and/or inventory—based on the image data streams—the spacial distribution of products 4 in shelves 3 or in sales area 2, wherein the expected and actual positions of each product 4 or at least most products 4 in sales area 2 are known.

The image data streams are transferred to a detection device 7 which, using digital image-processing algorithms, in particular video content analysis (VCA), detects products 4, determines their position in sales area 2, and identifies the products. For example, the detection of products 4 is based on a comparison of features (e.g. SIFT method), in which case features contained in a reference data base 8 which is a subset of a data base device 9 are compared with features in current camera images. For this purpose, reference data base 8 contains identification or feature information about every product 4 that is maintained in inventory, e.g. images of current views of the particular product. If significant conformances between a detected product 4 and a reference product contained in reference data base 8 are found, the position and identity of detected product 4 in the camera image is determined.

The data which are ascertained, i.e. position information and identification information, in particular, of every detected product 4, are forwarded to an assignment device 10 which compiles a storage plan for products 4 in sales area 2 and transfers it to data base device 9. Since the detection area of video monitoring system 1 typically extends across entire sales area 2, it is possible to monitor and record shelves 3 completely using monitoring cameras 5.

In addition to this basic functionality of inventory module 6, further functionalities are possible as options which are explained below.

It is possible for data base device 9 to contain a model 11 of sales area 2 with shelves 3, so that detected products 4 may be assigned to the local circumstances. In other embodiments, it is also possible, however, for model 11 to be created by inventory module 6

During operation it is possible to first carry out an initialization of inventory module 6, wherein sales area 6 which contains products 4 which have been organized completely and correctly is processed, in an image-based manner, and an expected state 12 is defined by evaluating this reference state of sales area 2. Expected state 12 may be stored in data base device 9 as a reference. As operation continues, particular actual state 13 of the product distribution is recorded, and it may be compared with the expected state in a comparator device 14. Once products 4 in shelves 3 have been completely categorized, it is possible for the system to automatically search for empty shelves 3, i.e. for shelves from which products 4 have already been removed. Using a control device 15 it is possible to control a human-machine interface 16 which informs the sales personnel that products 4 must be refilled. It is also possible to locate misplaced products 4, thereby enabling the sales personnel to return them to the correct location.

A further possible functionality may be carried out using an information terminal 17 which makes it possible to send a customer inquiry to inventory module 6, and to query and display the position and/or location of certain products 4. Further possibilities of supplemental functionalities include the detection of products 4 which have fallen to the floor, or an automatic optimization of the storage plan for product combinations, e.g. of products which are often purchased together.

A further addition to inventory module 6 relates to the steering of customers' purchasing behavior. For this purpose, inventory module 6 includes an object-detection device 18 which is designed to detect moving objects, in particular shoppers. The data on detected moving objects are transferred to a correlation device 19 which is also connected to data base device 9, and which may access expected state 12 or current state 13 of the storage plan of sales area 2. Correlation device 19 is designed to correlate the moving behavior of the customer to the location of products, and/or to recognize customers' selections when they remove a product 4 from shelves 3. Both variations make it possible for correlation device 19 to estimate the customer's interest in a certain product 4 and to alert the customer to similar products, combination products, or complementary products using advertising devices 20.

A further advantage of the automatic cataloging of products 4 in shelves 3 is that the location of products 4 need not be redetermined manually when sales area 2 is remodeled or reorganized. Inventory module 6 may automatically detect this change and automatically adjust storage plan 12 for additional devices (e.g. information terminal 17 for position determination) as well.

It will be understood that each of the elements described above, or two or more together, may also find a useful application in other types of constructions and methods differing from the types described above.

While the invention has been illustrated and described as embodied in an inventory module for a video monitoring system, method for taking inventory of a monitoring region, and a computer program, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. An inventory module for a video monitoring system, including at least one monitoring camera directed or directable to a monitoring region and a detection device for detecting products, so that when detection takes place, position information and information regarding an identification of a detected product are ascertained, the module comprising an assignment device configured to model, based on the position information and the identification information of a plurality of detected products, a spacial distribution of the products in the monitoring region.

2. The inventory module as defined in claim 1, further comprising a data base device which is configured to store the product distribution in the monitoring region.

3. The inventory module as defined in claim 2, wherein said data base device is configured to store a model of the monitoring region, with the product distribution being entered in the model or being linked thereto.

4. The inventory module as defined in claim 2, wherein said data base device is designed so that an expected state of an arrangement of the products in the monitoring region is stored in the data base device.

5. The inventory module as defined in claim 4, further comprising a comparator device configured to compare an actual state of the monitoring region with an expected state of the monitoring region.

6. The inventory module as defined in claim 2, wherein said data base device includes a reference data base in which identification data of the products are stored.

7. The inventory module as defined in claim 1, further comprising an object-detection device which is configured to detect moving objects, and a correlation device which is configured to correlate a moving behavior of the moving objects with an arrangement of the products.

8. The inventory module as defined in claim 7, wherein said object-detection device is configured to detect shoppers.

9. The inventory module as defined in claim 7, further comprising a control device configured to control, based on results of said correlation device, information terminals which are used to inform a customer in a selective manner.

10. The inventory module as defined in claim 1, wherein the inventory module is configured so that the at least one monitoring camera is directed or directable to a storage and/or sales area which contains products.

11. A method for taking inventory of a monitoring region containing products, comprising the steps of detecting the products; ascertaining position and identification information; and modeling a spacial distribution of the products in the monitoring region.

12. A method for taking inventory of a monitoring region as defined in claim 11, wherein the method is provided for taking inventory in the monitoring region which is a region selected from the group consisting of a storage region, a sales region, and both.

13. The method as defined in claim 11, further comprising ascertaining an expected state of a product distribution, and comparing the expected state during operation with an actual state of the product distribution.

14. A computer program with program code means for carrying out all steps of the method as defined claim 11 when the program is run on a computer.

15. A computer program with program code means for carrying out all steps of the method as defined claim 11 when the program is run on a device as recited in claim 1.

16. A computer program with program code means for carrying out the steps of the method as recited in claim 10 when the program is run on a computer and on the device as recited in claim 1.
